(19) United States
(12) Patent Application Publication
(10) Pub. No.: US 2021/0287838 A1
(43) Pub. Date: Sep. 16, 2021

(54) INDUCTOR COMPONENT

(71) Applicant: Murata Manufacturing Co., Ltd., Kyoto-fu (JP)

(72) Inventors: Ikuno SUGIYAMA, Nagaokakyo-shi (JP); Shinya HIRAI, Nagaokakyo-shi (JP); Shin HASEGAWA, Nagaokakyo-shi (JP)

(73) Assignee: Murata Manufacturing Co., Ltd., Kyoto-fu (JP)

(21) Appl. No.: 17/202,069

(22) Filed: Mar. 15, 2021

(30) Foreign Application Priority Data
Mar. 16, 2020 (JP) 2020-045305

(51) Int. Cl. H01F 17/04; H01F 27/30; H01F 27/32; H01F 27/29

(52) U.S. Cl. CPC H01F 17/045; H01F 27/292; H01F 27/324; H01F 27/306

(57) ABSTRACT

A coil component according to the present disclosure comprises a ring-shaped core; an insulating member which covers a portion of the ring-shaped core; and a coil which is wound around the core and the insulating member. The coil comprises a plurality of pin members in which end portions of adjacent pin members share a welded portion at which the end portions are welded to each other, and the insulating member is located between the welded portion and the core. Thus, an inductance value of an inductor component can be improved.

### CROSS-REFERENCE TO RELATED APPLICATION

This application claims benefit of priority to Japanese Patent Application No. 2020-045305, filed Mar. 16, 2020, the entire content of which is incorporated herein by reference.

### BACKGROUND

### Technical Field

The present disclosure relates to an inductor component.

### Background Art

Heretofore, as an inductor component, one which is disclosed in International Publication No. 2017/169737 is known. In International Publication No. 2017/169737, a coil component comprising a ring-shaped core and a coil wound around the coil is disclosed, wherein the coil is composed of a plurality of wire members that are connected to each other. In International Publication No. 2017/169737, the plurality of wire members include bent wire members each of which is bent in an approximately U-shape and straight wire members each of which extends in an approximately straight-line-like shape.

In Japanese Patent Application Publication Laid-open No. 2013-93388, an electronic component equipped with a coil bobbin 4 in which a toroidal core 3 is housed and around which a coil is wound is disclosed (see, for example, FIG. 1).

### SUMMARY

In the coil disclosed in International Publication No. 2017/169737, for the purpose of ensure the insulation and fixation between a plurality of wire members (i.e., pin members) and a core, the wire members and the core are coated with an insulating member. In this case, however, it is concerned that the core is influenced by magnetostriction and thereby the inductance value of the inductor component may be reduced.

In Japanese Patent Application Publication Laid-open No. 2013-93388, on the other hand, any bonding agent is not used for the housing of the electronic component in a housing case, and therefore it is considered that the influence of magnetostriction on the core can be reduced.

However, as the result of the studies made by the present inventors, it is found that, when a bobbin as described in Japanese Patent Application Publication Laid-open No. 2013-93388 is used in International Publication No. 2017/169737, the inductance value of the inductor component becomes small. It is assumed that this is because, in International Publication No. 2017/169737, since the coil has a straight wire member (i.e., a straight pin members) and a bent wire member (i.e., a bent pin member), when the coil is used in combination with the coil bobbin, the distance between the pin member and the core increases by the thickness of the bobbin, resulting in the reduction in cross-sectional area of the core in the peripheral direction.

In these situations, the present disclosure improves an inductance value of an inductor component.

Therefore, an inductor component according to one aspect of the present disclosure comprises a ring-shaped core; an insulating member which covers a portion of the core; and a coil which is wound around the core and the insulating member. the coil comprises a plurality of pin members in which end portions of adjacent pin members share a welded portion at which the end portions are welded to each other, and the insulating member being located between the welded portion and the core.

According to this embodiment, it becomes possible to insulate the welded portions from the core by providing the insulating member. Furthermore, because only a portion of the core is covered with the insulating member, the influence of magnetostriction can be reduced compared with the case where the whole surface of the core is covered with the insulating member. Furthermore, according to the above-mentioned aspect, a part occupied by the insulating member can be replaced by the core and thereby the cross-sectional area of the core can be increased compared with the case where the whole surface of the core is covered with the insulating member. As a result, according to the above-mentioned aspect, the inductance value of the inductor component can be increased.

In one embodiment of the inductor component, the insulating member is connected to the core indirectly.

According to this embodiment, because the insulating member is not connected to the core directly, the influence of magnetostriction can be further reduced.

In one embodiment of the inductor component, the plurality of pin members include a first pin member and a second pin member. The first pin member and the second pin member together constitute a single turn. Also, in adjacent turns, the welded portion includes a first welded portion at which the first pin member in one of the turns and the second pin member in the one of the turns are welded to each other and a second welded portion at which the first pin member in the one of the turns and the second pin member in the other of the turns are welded to each other. The core has a first surface, a second surface which intersects the first surface, and a third surface which faces the second surface and intersects the first surface. The first welded portion is located above at least one of the first surface and the second surface, the second welded portion is located above at least one of the first surface and the third surface, and the insulating member is provided over the first surface, a portion of the second surface and a portion of the third surface.

According to the above-mentioned embodiment, the insulation between the core and the coil can become made more satisfactory.

With respect to the wording “the first surface and the second surface intersect each other”, the first surface and the second surface may intersect each other physically. For example, in the case where the first surface and the second surface are connected to each other with a curved portion interposed therebetween, an extended plane of the first surface and an extended plane of the second surface may intersect each other.

The wording “an object is located above the first surface” refers to a phenomenon that the object is located on the upper side than the surface of the first surface in the direction orthogonal to the first surface. The wording “the first welded portion is located above the first surface” refers to a phenomenon that the first welded portion is located without being in direct contact with the first surface. The same can apply to the second to fourth surfaces and the second welded portion.

In one embodiment of the inductor component, the plurality of pin members include a third pin member which constitutes a single turn, in adjacent turns, the welded portion includes a third welded portion which is provided at the third pin member in one of the turns and the third pin member in the other of the turns, the core has a first surface and a second surface which intersects the first surface, the third welded portion is located above at least one of the first surface and the second surface, and the insulating member is provided over a portion of the first surface and a portion of the second surface.

According to the above-mentioned embodiment, the insulation between the core and the coil can become made more satisfactory.

In one embodiment of the inductor component, the core has a fitting groove into which the insulating member is fitted.

According to the above-mentioned embodiment, the extension of the insulating member beyond the edge of outer surface of the core can be reduced. Furthermore, it becomes possible to attach the insulating member easily, and the misalignment of the insulating member can be prevented.

In one embodiment of the inductor component, the fourth surface of the core which the welded portion does not face is not covered with the insulating member.

According to the above-mentioned embodiment, it becomes possible to increase the size of the core in the direction in which the fourth surface of the core is brought close to the coil, and consequently it becomes possible to further increase the cross-sectional area of the core.

In one embodiment of the inductor component, the core has a fourth surface which the welded portion does not face and a second surface which intersects the fourth surface. The pin member has a first straight portion which faces the fourth surface, a second straight portion which faces the second surface, and a curved portion which is located between the first straight portion and the second straight portion. The insulating member has a first portion which is located between the second surface of the core and the second straight portion of the pin member, and an extended plane of the first portion which is located on a side of the second straight portion intersects the curved portion.

According to the above-mentioned embodiment, it becomes possible to increase the size of the core in the direction in which the second surface of the core is brought close to the second straight portion of the coil, and consequently it becomes possible to further increase the cross-sectional area of the core.

In one embodiment of the inductor component, the core has a fourth surface which the welded portion does not face and a second surface which intersects the fourth surface. The pin member has a first straight portion which faces the fourth surface, a second straight portion which faces the second surface, and a curved portion which is located between the first straight portion and the second straight portion. the insulating member has a first portion which is located between the second surface of the core and the second straight portion of the pin member, and an end surface of the first portion which is located on the first straight portion side is formed on the same plane as an interface between the second straight portion and the curved portion.

According to the above-mentioned embodiment, it becomes possible to extend the insulating member to a curved portion of the coil. As a result, the insulation between the core and the coil can be secured more reliably.

In one embodiment of the inductor component, the core has a first surface, a fourth surface which faces the first surface and which the welded portion does not face, and a second surface which intersects the first surface and the fourth surface. The pin member has a straight portion which faces the second surface. the insulating member has a first portion which is located between the second surface of the core and the straight portion of the pin member and a third portion which faces the first surface of the core. A ratio of a shortest distance between an extended plane of the third portion which is located on the first surface side and an end surface of the first portion to a shortest distance between the first surface and the fourth surface is 0.2 to 0.9 inclusive.

According to the above-mentioned embodiments, a creepage distance can be kept long and the insulation between the core and the coil can be made more satisfactory.

According to an inductor component which is one embodiment of the present disclosure, it becomes possible to improve the inductance value of the inductor component.

### BRIEF DESCRIPTION OF THE DRAWINGS

FIG. 1 is an upper perspective view of an inductor component according to a first embodiment of the present disclosure;

FIG. 2 is a lower perspective view of the inductor component;

FIG. 3 is an upper perspective view showing the inside of the inductor component;

FIG. 4 is an exploded perspective view of the inductor component;

FIG. 5 is a sectional view of the inductor component;

FIG. 6 is a sectional view of the inductor component;

FIG. 7 is an enlarged view of a region A shown in FIG. 6;

FIG. 8 is an enlarged view of a region B shown in FIG. 6;

FIG. 9 is an enlarged sectional view of an inductor component according to a second embodiment of the present disclosure;

FIG. 10 is an enlarged sectional view of an inductor component according to a third embodiment of the present disclosure;

FIG. 11A is a perspective view of an inductor component according to a fourth embodiment of the present disclosure;

FIG. 11B is an exploded perspective view of the inductor component according to the fourth embodiment of the present disclosure;

FIG. 12 is an enlarged sectional view of an inductor component according to a fifth embodiment of the present disclosure; and

FIG. 13 is an enlarged sectional view of an inductor component according to a sixth embodiment of the present disclosure.

### DETAILED DESCRIPTION

Hereinbelow, an inductor component, which is one aspect of the present disclosure, is described in more detail with reference to the embodiments shown in the drawings. The drawings include some schematic ones, in which real dimensions and proportions may not be reflected.

### First Embodiment

### Configuration of Inductor Component

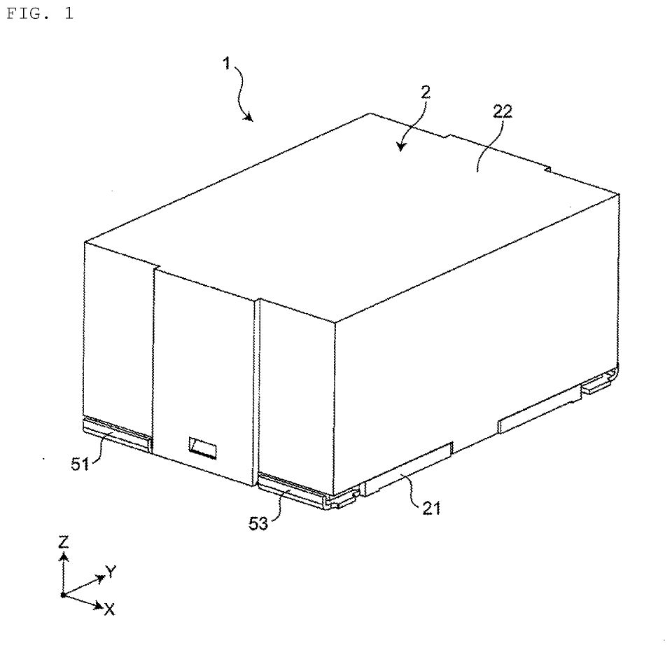

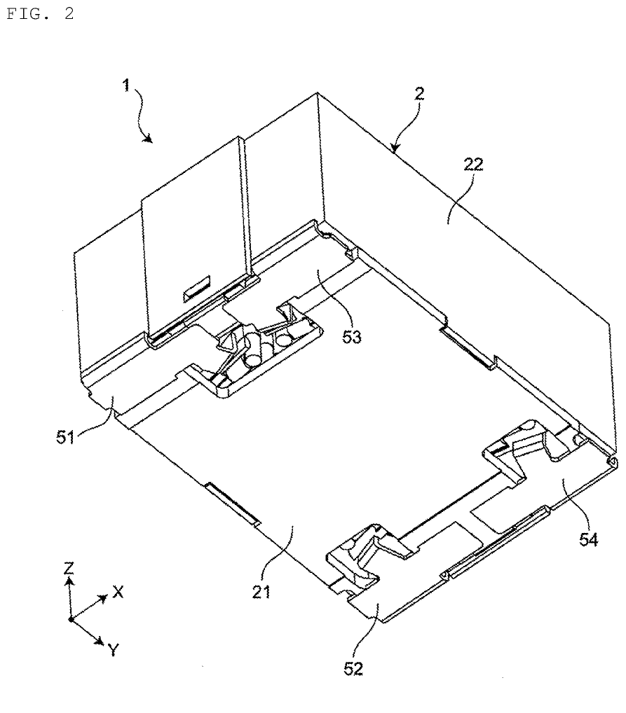

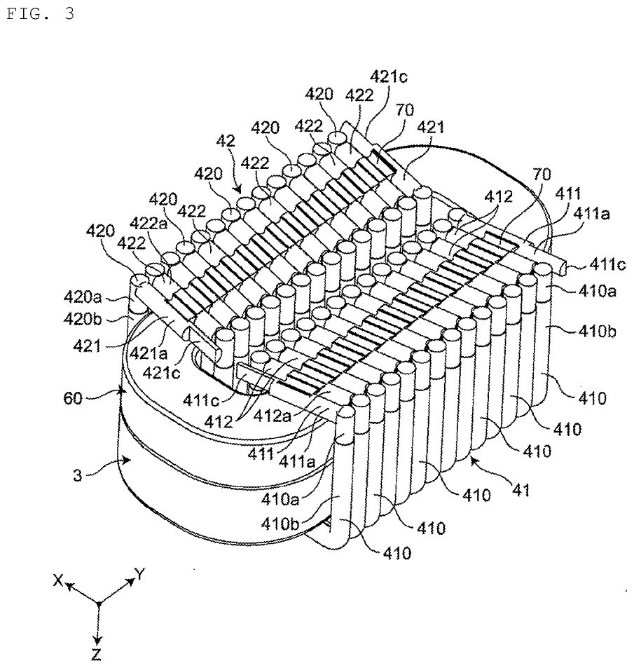

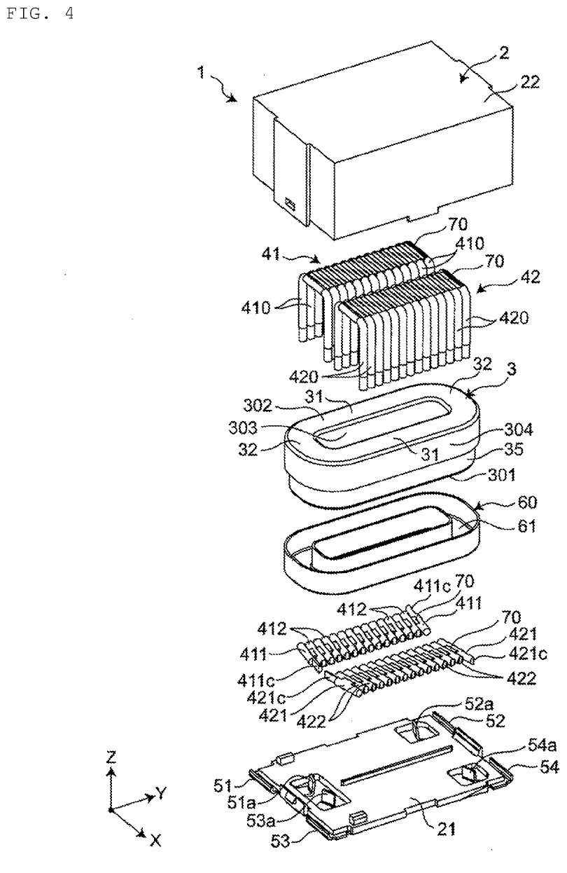

FIG. 1 is an upper perspective view showing an inductor component according to one embodiment of the present disclosure. FIG. 2 is a lower perspective view of the inductor component. FIG. 3 is an upper perspective view showing the inside of the inductor component. FIG. 4 is an exploded perspective view of the inductor component.

As shown in FIGS. 1 to 4, an inductor component 1 comprises a case 2, a ring-shaped core 3 housed in the case 2, a first coil 41 and a second coil 42 both wound around the core 3, and a first electrode terminal 51 to a fourth electrode terminal 54 attached to the case 2 and connected to the first coil 41 and the second coil 42. One example of the inductor component 1 is a common mode choke coil.

The case 2 comprises a bottom plate part 21 and a box-shaped lid part 22 that covers the bottom plate part 21. The case 2 is made from a material having strength and heat resistance, preferably a material having flame retardancy. The case 2 is made from, for example, a resin such as polyphenylene sulfide (PPS), a liquid crystalline polymer (LCP) and polyphthalamide (PPA) or a ceramic. On the bottom plate part 21, the core 3 is placed in such a manner that a center axis of the core 3 intersects the bottom plate part 21 at right angles. The term “center axis of the core 3” as used herein refer to a center axis of an inner-diameter hole part of the core 3. The shape of the case 2 (including the bottom plate part 21 and the lid part 22) is quadrilateral as observed from the direction of the center axis of the core 3. In this embodiment, the shape of the case 2 is rectangular.

It is defined as follows: the shorter direction of the case 2 as observed from the direction of the center axis of the core 3 is X-direction, the longer direction of the case 2 as observed from the direction of the center axis of the core 3 is Y-direction, and the height direction of the case 2 which is a direction perpendicular to both of the shorter direction and the longer direction is Z-direction. The bottom plate part 21 and the lid part 22 in the case 2 are arranged so as to face each other in Z-direction, in which the bottom plate part 21 is located on a lower side and the lid part 22 is located on an upper side. The direction toward the upper side is defined as a forward direction of the z-direction, and the direction toward the lower side is defined as a backward direction of the z-direction. In the case where the shape of the bottom plate part 21 of the case 2 is square, the length of the case 2 in the X-direction is identical to the length of the case 2 in the Y-direction.

The first to fourth electrode terminals 51 to 54 are attached to the bottom plate part 21. The first electrode terminal 51 and the second electrode terminal 52 are located at two corners that face each other in the Y-direction on the bottom plate part 21, and the third electrode terminal 53 and the fourth electrode terminal 54 are located at two corners that face each other in the Y-direction on the bottom plate part 21. The first electrode terminal 51 and the third electrode terminal 53 face each other in the X-direction, and the second electrode terminal 52 and the fourth electrode terminal 54 face each other in the X-direction.

The shape of the core 3 is oval (track-like shape) as observed from the directions of the center axis of the core 3. The core 3 includes a pair of longer-side parts 31 which extend along the longer axis and face each other in the shorter axis direction and a pair of shorter-side parts 32 which extend along the shorter axis and face each other in the longer axis direction as observed from the center axis direction. The shape of the core 3 may be rectangular or elliptic as observed from the center axis direction.

The core 3 is composed of, for example, a ceramic core made from ferrite or the like or a magnetic core made from an iron-based powder molded article or a nano-crystal foil. The core 3 has a first end surface 301 and a second end surface 302 which face each other in the center axis direction and an inner peripheral surface 303 and an outer peripheral surface 304. The first end surface 301 is an end surface located on the lower side of the core 3 and faces the inner surface of the bottom plate part 21. The second end surface 302 is an end surface located on the upper side of the core 3 and faces the inner surface of the lid part 22. The core 3 is housed in the case 2 in such a manner that the longer axis direction of the core 3 can be consistent with the Y-direction.

In this embodiment, the first end surface 301, the second end surface 302, the inner peripheral surface 303 and the outer peripheral surface 304 respectively correspond to the first surface, the fourth surface, the second surface and the third surface recited in the claims.

The shape of a cross section of the core 3 which is orthogonal to the peripheral direction as observed from the direction of the center axis of the core 3 is quadrilateral. The first end surface 301 and the second end surface 302 are arranged perpendicular to the direction of the center axis of the core 3. The inner peripheral surface 303 and the outer peripheral surface 304 are arranged in parallel with the direction of the center axis of the core 3. The term “perpendicular” as used herein includes an absolutely perpendicular state as well as a substantially perpendicular state. The term “parallel” as used herein includes an absolutely parallel state as well as a substantially parallel state.

The lower side part of the core 3 is covered with an insulating member 60. That is, a portion of the core 3 is covered with the insulating member 60. In other words, the core 3 is not covered with the insulating member 60 wholly. The insulating member 60 is made from, for example, a super engineering plastic such as LCP, PPA and PPS, and therefore the heat resistance, insulation properties and processability of the insulating member 60 can be improved.

The insulating member 60 is formed into a ring-shaped form, and has a ring-shaped depressed part 61 that covers the lower side part of the core 3. The insulating member 60 can be installed on the core 3 by fitting the lower side part of the core 3 into the ring-shaped depressed part 61 of the insulating member 60.

The core 3 has a fitting groove 35 into which the insulating member 60 is fitted. The fitting groove 35 is opened at a first end surface 301, an outer peripheral surface 304 and an inner peripheral surface 303 of the core 3. The width of the first end surface 301 of the core 3 is smaller than that of the second end surface 302 of the core 3. The width of the insulating member 60 can be prevented from becoming too large compared with the width of the second end surface 302 of the core 3 by fitting the outer peripheral surface of the insulating member 60 into the fitting groove 35 of the core 3. Furthermore, it becomes possible to make the installation of the insulating member 60 more easy and the misalignment of the insulating member 60 can be prevented.

The first coil 41 is wound around the core 3 and the insulating member 60 in an area between the first electrode terminal 51 and the second electrode terminal 52. One end of the first coil 41 is connected to the first electrode terminal 51. The other end of the first coil 41 is connected to the second electrode terminal 52.

The second coil 42 is wound around the core 3 and the insulating member 60 in an area between the third electrode terminal 53 and the fourth electrode terminal 54. One end of the second coil 42 is connected to the third electrode terminal 53. The other end of the second coil 42 is connected to the fourth electrode terminal 54.

The first coil 41 and the second coil 42 are wound along the longer axis direction. That is, the first coil 41 is wound around one of the longer-side parts 31 of the core 3, and the second coil 42 is wound around the other of the longer-side parts 31 of the core 3. The winding axis of the first coil 41 and the winding axis of the second coil 42 are parallel with each other. The first coil 41 and the second coil 42 become symmetrical with respect to the longer axis of the core 3.

The number of winding turns of the first coil 41 and that of the second coil 42 are the same as each other. The direction of winding of the first coil 41 around the core 3 and that of the second coil 42 around the core 3 are opposite to each other. That is, the direction of winding of the first coil 41 from the first electrode terminal 51 toward the second electrode terminal 52 and that of the second coil 42 from the third electrode terminal 53 toward the fourth electrode terminal 54 are opposite to each other.

A common-mode electric current flows from the first electrode terminal 51 toward the second electrode terminal 52 in the first coil 41, and also flows from the third electrode terminal 53 toward the fourth electrode terminal 54 in the second coil 42. That is, the first to fourth electrode terminals 51 to 54 are connected in such a manner that the direction of the flow of the common-mode electric current in the first coil 41 and that in the second coil 42 can become identical to each other. When the common-mode electric current flows in the first coil 41, a first magnetic flux generates by the action of the first coil 41 in the core 3. When the common-mode electric current flows in the second coil 42, a second magnetic flux generates in the core 3 in such a direction that the second magnetic flux can be intensified with the first magnetic flux in the core 3. As a result, the first coil 41 and the core 3 and the second coil 42 and the core 3 act as inductance components, and thereby noises against the common-mode electric current can be removed.

The first coil 41 is composed of a plurality of pin members which are connected to each other by welding such as laser welding and spot welding. FIG. 3 illustrates a state where the plurality of pin members are assembled, rather than a state where the plurality of pin members are actually welded.

The plurality of pin members are bar-shaped members, rather than printed wirings or conducting wires. Each of the pin members has rigidity and is more difficult to bent than a conducting wire that has been used for the connection between electric component modules. More specifically, in a cross section orthogonal to the direction of the periphery of the core 3, each of the pin members is shorter than the length of a single turn around the outer periphery of the core which passes through the first end surface 301, the second end surface 302, the inner peripheral surface 303 and the outer peripheral surface 304 of the core 3. Furthermore, each of the pin members has high rigidity. Therefore, each of the pin members cannot be bent easily.

The plurality of pin members include a bent pin member 410 which is bent in an approximately U-shape and a straight pin member 411, 412 which extends in an approximately straight-line-like shape. In this embodiment, the bent pin member 410 and the straight pin member 411, 412 respectively correspond to the “second pin member” and the “first pin member” recited in the claims.

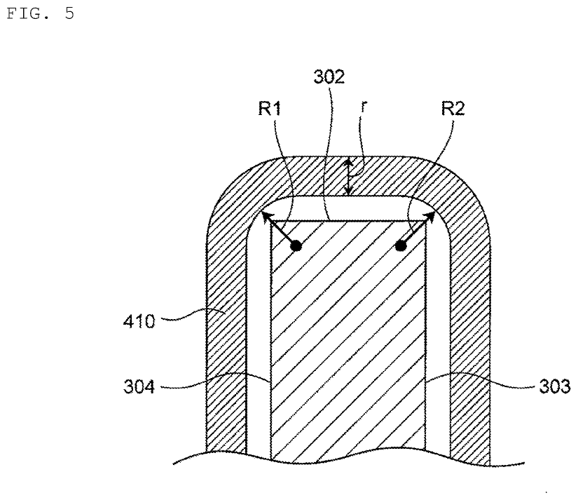

The first coil 41 includes, in the direction from one end toward the other end, a (one) first straight pin member 411 located on one end side, a plurality of (bent pin member 410)-(second straight pin member 412) sets, and a (the other) first straight pin member 411 located on the other end side. The length of the first straight pin member 411 and that of the second straight pin member 412 are different from each other. The spring index of the bent pin member 410 is described here. When the bent pin member 410 is arranged along the second end surface 302, the inner peripheral surface 303 and the outer peripheral surface 304 of the core 3 as shown in FIG. 5, the spring index Ks of the bent pin member 410 at each of a radius of curvature R1 of the bent pin member 410 located at a corner part of the outer peripheral surface 304 of the core 3 and a radius of curvature R2 of the bent pin member 410 located at a corner of the inner peripheral surface 303 of the core 3 is smaller than 3.6. The spring index Ks is expressed by the formula: (radius of curvature R1, R2 of the bent pin member)/(wire diameter r of the bent pin member). As mentioned above, the bent pin member 410 has high rigidity and cannot be bent easily.

The bent pin members 410 and the second straight pin members 412 are connected alternatively by welding such as laser welding and spot welding. One end of a second straight pin member 412 is connected to one end of a bent pin member 410, and the other end of the second straight pin member 412 is connected to one end of another bent pin member 410. By repeating this procedure, a plurality of bent pin members 410 and a plurality of second straight pin members 412 are connected. The plurality of bent pin members 410 and the plurality of second straight pin members 412 thus connected are arranged spirally around the core 3. That is, one turn is composed of a single (bent pin member 410)-(second straight pin member 412) set.

The bent pin members 410 are arranged in parallel with each other along each of the second end surface 302, the inner peripheral surface 303 and the outer peripheral surface 304 of the core 3. The second straight pin members 412 are arranged in parallel with each other along the first end surface 301 of the core 3. The first straight pin members 411 are arranged in parallel with each other along the first end surface 301 of the core 3.

The bent pin members 410 in adjacent turns are fixed to each other by a bonding member 70. In this manner, the attachment of the plurality of bent pin members 410 to the core 3 can be made stable. Similarly, a first straight pin member 411 and a second straight pin member 412 that are adjacent to each other are fixed to each other by the bonding member 70, and second straight pin members 412 that are adjacent to each other are fixed to each other by the bonding member 70. In this manner, the attachment of the plurality of first straight pin members 411 and the plurality of second straight pin members 412 to the core 3 can be made stable.

The first electrode terminal 51 is connected to one of the first straight pin members 411, and the one of the first straight pin members 411 is connected to one end of a bent pin member 410 in a turn adjacent to the one of the first straight pin members 411. The one of the first straight pin members 411 has an attachment strip 411c. The first electrode terminal 51 has an attachment part 51a that enters the case 2. The attachment strip 411c in the one of the first straight pin members 411 is connected to the attachment part 51a in the first electrode terminal 51.

The second electrode terminal 52 is connected to the other of the first straight pin members 411, and the other of the first straight pin members 411 is connected to one end of a second straight pin member 412 in a turn adjacent to the other of the first straight pin members 411. An attachment strip 411c in the other of the first straight pin members 411 is connected to an attachment part 52a in the second electrode terminal 52.

Like the first coil 41, the second coil 42 is also composed of a plurality of pin members. The second coil 42 includes, in the direction from one end toward the other end, a (one) first straight pin member 421 located on one end side, a plurality of (bent pin member 420)-(second straight pin member 422) sets, and a (the other) first straight pin member 421 located on the other end side. The bent pin members 420 and the second straight pin members 422 are connected alternatively and are wound around the core 3. That is, the plurality of bent pin members 420 and the plurality of second straight pin members 422 are connected, and the plurality of bent pin members 420 and the plurality of second straight pin members 422 thus connected are wound spirally around the core 3.

The third electrode terminal 53 is connected to the one first straight pin member 421, and the one first straight pin member 421 is connected to one end of the bent pin member 420 in the turn adjacent to the one first straight pin member 421. The attachment strip 421c in the one first straight pin member 421 is connected to the attachment part 53a in the third electrode terminal 53.

The fourth electrode terminal 54 is connected to the other first straight pin member 421, and the other first straight pin member 421 is connected to one end of a second straight pin member 412 in a turn adjacent to the other first straight pin member 421. The attachment strip 421c in the other first straight pin member 421 is connected to an attachment part 54a in the fourth electrode terminal 54.

As shown in FIG. 3, each of the first coil 41 and the second coil 42 (respectively including the pin members 410 to 412 and the pin members 420 to 422) includes an electrically conductive body part and a coating film that covers the electrically conductive body part. One example of the electrically conductive body part is a copper wire, and one example of the coating film is a polyamideimide resin. The thickness of the coating film is, for example, 0.02 to 0.04 mm.

The first straight pin member 411, 421 is composed of an electrically conductive body part 411a, 421a having no coating film. The second straight pin member 412, 422 is composed of an electrically conductive body part 412a, 422a having no coating film. The bent pin member 410, 420 is composed of an electrically conductive body part 410a, 420a and a coating film 410b, 420b.

The electrically conductive body part 410a, 420a is exposed from the coating film 410b, 420b at one end and the other end of the bent pin member 410, 420. That is, the first straight pin member 411, 421, the second straight pin member 412, 422 and the bent pin member 410, 420 are welded to one another at the exposed electrically conductive body part 411a, 421a, 412a, 422a, 410a, 420a.

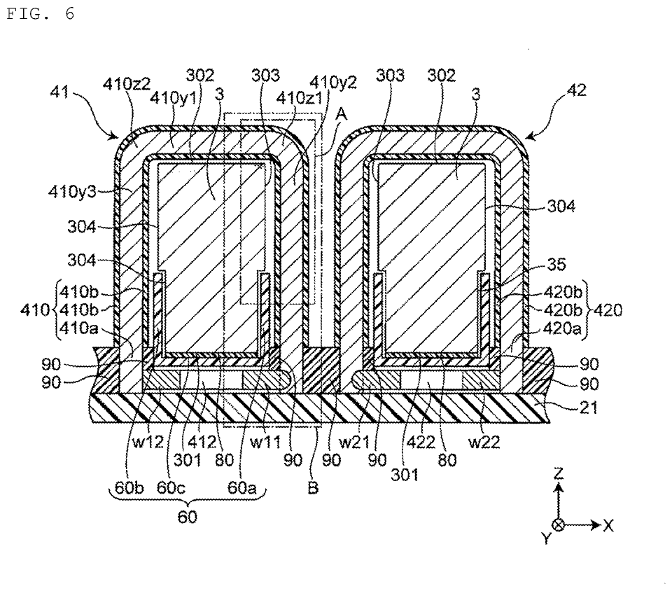

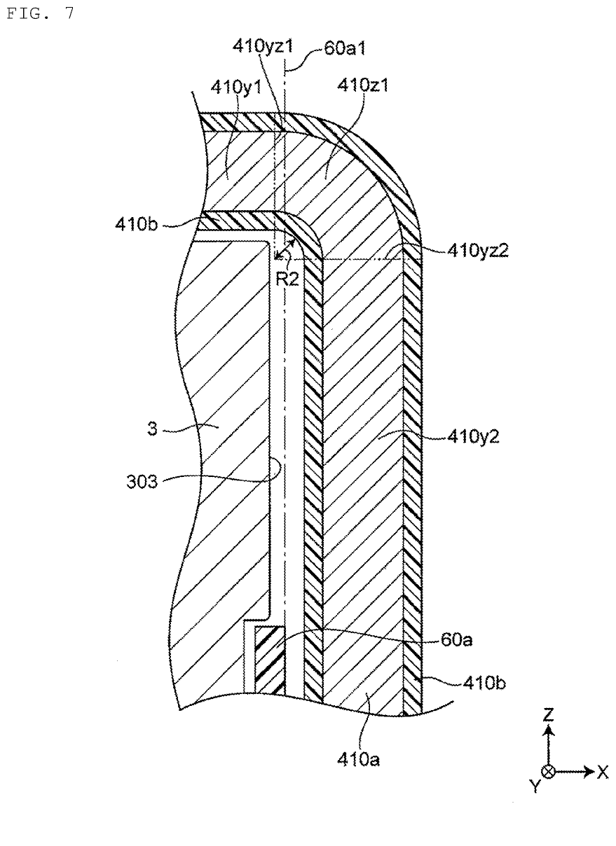

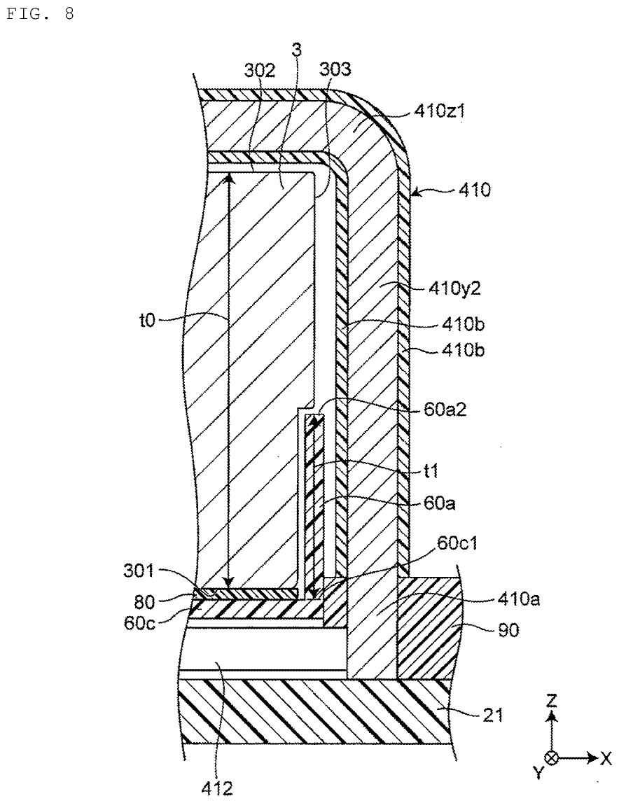

FIG. 6 is an XZ sectional view that passes through a Y-direction center of the inductor component 1. FIG. 7 is an enlarged view of a region A shown in FIG. 6. FIG. 8 is an enlarged view of a region B shown in FIG. 6.

As shown in FIG. 6, the bent pin members 410 has a first straight portion 410y1 that faces the second end surface 302 of the core 3, a second straight portion 410y2 that faces the inner peripheral surface 303 of the core 3, a curved portion 410z1 that is located between the first straight portion 410y1 and the second straight portion 401y1, a third straight portion 410y3 that faces the outer peripheral surface 304 of the core 3, and a curved portion 410z2 that is located between the first straight portion 410y1 and the third straight portion 401y2. In this section, the first coil 41 is described. The second coil 42 has the same structure as that of the first coil 41.

As shown in FIG. 6, in the first coil 41, end portions of adjacent pin members share a welded portion at which the pin members are welded to each other. The term “welded portion” as used herein refers to a part which is melted upon welding and is solidified thereafter. More specifically, the first coil 41 has a first welded portion w11 and a second welded portion w12. Still more specifically, in adjacent turns in the first coil 41, a second straight pin member 412 and a bent pin member 410 in one of the turns form a first welded portion w11 at which one electrically conductive body part 412a in the second straight pin members 412 and an electrically conductive body part 410a in the bent pin member 410 are welded to each other, and the second straight pin members 412 and a bent pin member 410 in the other of the turns form a second welded portion w12 at which the other electrically conductive body part 412a in the second straight pin member 412 and an electrically conductive body part 410a in the bent pin member 410 are welded to each other. In FIG. 6, the shape of each of the first welded portion w11 and the second welded portion w12 is straight-line-like shape, but may not be a straight-line-like shape.

The first welded portion w11 is located above the first end surface 301 of the core 3. In this regard, the wording “the first welded portion w11 is located above the first end surface 301” means that it is only required that at least a portion of the first welded portion w11 is located above the first end surface 301. The first welded portion w11 may be in directly contact with the first end surface 301 of the core 3, or may be in indirectly contact with the first end surface 301 with a space interposed therebetween.

In FIG. 6, an aspect in which the first welded portion w11 is located above the first end surface 301 is illustrated. However, the first welded portion w11 may be located above the inner peripheral surface 303 of the core 3, or may be located above the first end surface 301 and the inner peripheral surface 303 of the core 3.

For example, the wording “the first welded portion w11 is located above the inner peripheral surface 303” means that it is only required that at least a portion of the first welded portion w11 is located above the inner peripheral surface 303. The wording “the first welded portion w11 is located above the inner peripheral surface 303” means that the first welded portion w11 is located above relative to the surface of the inner peripheral surface 303, and does not mention about whether the first welded portion w11 is illustrated at an upper position or a lower position in the drawing. With respect to other surfaces than the inner peripheral surface 303, the wording “located above” has the same meaning as mentioned above.

The first welded portion w11 may be located above the first end surface 301 while facing a first corner part located between the first end surface 301 and the inner peripheral surface 303 of the core 3 or, alternatively, may be located above the inner peripheral surface 303 while facing the first corner part or, alternatively, may be located above the first end surface 301 and the inner peripheral surface 303 while facing the first corner part. In another aspect, the first welded portion w11 may be arranged so as to face only the first corner part located between the first end surface 301 and the inner peripheral surface 303 of the core 3. In the case where the shape of the first corner part is a curved shape in a cross section orthogonal to the direction orthogonal to the peripheral direction of the core 3, the first corner part is located between the planar first end surface 301 and the planar inner peripheral surface 303. In the case where the shape of the first corner part is a point, the first corner part is a point at which the planar first end surface 301 and the planar inner peripheral surface 303 intersect each other.

The second welded portion w12 is located above the first end surface 301 of the core 3. In this regard, the wording “the second welded portion w12 is located above the first end surface 301” means that it is only required that at least a portion of the second welded portion w12 is located above the first end surface 301.

In FIG. 6, an aspect in which the second welded portion w12 is located above the first end surface 301 is illustrated. However, the second welded portion w12 may be located above the outer peripheral surface 304 of the core 3, or may be located above the first end surface 301 and the outer peripheral surface 304 of the core 3. In this regard, the wording “the second welded portion w12 is located above the outer peripheral surface 304” means that it is only required that at least a portion of the second welded portion w12 is located above the outer peripheral surface 304.

In another aspect, the second welded portion w12 may be arranged so as to face only the second corner part located between the first end surface 301 and the outer peripheral surface 304 of the core 3.

In FIG. 6, a turn composed of the second straight pin member 412 and the bent pin member 410 in the first coil 41 is illustrated. However, the same descriptions can apply to a turn composed of the first straight pin member 411 and the bent pin member 410. More specifically, the first straight pin member 411 is welded at the electrically conductive body part 410a in the bent pin member 410 which is connected to the electrically conductive body part 411a to form the first welded portion w11 or the second welded portion w12.

The second coil 42 has the first welded portion w21 and the second welded portion w22. In the second coil 42, as in the case of the first coil 41, in adjacent turns, the second straight pin member 422 and the bent pin member 420 in one of the turns are welded to each other at one electrically conductive body part 422a in the second straight pin member 422 and an electrically conductive body part 420a in the bent pin member 420 to form a first welded portion w21, and the second straight pin members 422 and the bent pin member 420 in the other of the turns are welded to each other at the other electrically conductive body part 422a in the second straight pin member 422 and the electrically conductive body part 420a in the bent pin member 420 to form a second welded portion w22. The first straight pin member 421 is welded at the electrically conductive body part 420a in the bent pin member 420 which is connected to the electrically conductive body part 421a to form the first welded portion w21 or the second welded portion w22. The first welded portion w21 and the second welded portion w22 in the second coil 42 have the same structures as those of the first welded portion w11 and the second welded portion w21 in the first coil 41, respectively. Accordingly, the explanation about the structures is omitted.

The insulating member 60 is located between the welded portions and the core 3. For example, in the case where the insulating member is provided on the whole area of the outer surface of the core 3, the influence of magnetostriction on the core 3 becomes too large. Particularly when a hard resin is used as the insulating member, the above-mentioned influence is increased. In contrast, in this embodiment, a portion of the core 3 is covered with the insulating member 60. In other words, the core 3 has a portion that is not covered with the insulating member 60. As a result, the influence of magnetostriction can be reduced compared with the case where the whole area of the core 3 is covered with the insulating member. Furthermore, when the insulating member 60 is provided only on a portion of the core 3, the cross-sectional area of the core 3 can be increased compared with the case where the insulating member is provided on the whole area of the outer surface of the core. As mentioned above, according to this embodiment, it becomes possible to increase the inductance value of the inductor component. In this embodiment, the insulating member 60 is only required to be provided at a portion of the core 3. Therefore, the insulating member 60 can be provided only at a desired position (which is located between the welded portion and the core 3). When the insulating member 60 is provided between all of the welded portions and the core 3, it becomes possible to insulate between the welded portions and the core 3 more reliably.

The insulating member 60 is provided over the first end surface 301, a portion of the inner peripheral surface 303 and a portion of the outer peripheral surface 304 of the core 3. As a result, the insulation between the core 3 and the first coil 41 can be made more satisfactory. More specifically, the insulating member 60 covers a first corner part located between the first end surface 301 and the inner peripheral surface 303 and a second corner part located between the first end surface 301 and the outer peripheral surface 304. The insulating member 60 has a first portion 60a located between the inner peripheral surface 303 of the core 3 and the second straight portion 410y2 in the bent pin member 410, a second portion 60b located between the outer peripheral surface 304 of the core 3 and the third straight portion 410y3 of the bent pin member 410, and a third portion 60c located between the first end surface 301 of the core 3 and the second straight pin member 412.

It is preferred that the second end surface 302 which the welded portion in the core 3 does not face is not covered with the insulating member 60. As a result, it becomes possible to increase the size of the core 3 in a direction in which the second end surface 302 of the core 3 is brought close to the first coil 41 and the second coil 42, and consequently it becomes possible to further increase the cross-sectional area of an XZ-direction cross section of the core 3.

The insulating member 60 is connected to the core 3 indirectly. That is, the insulating member 60 is not connected to the core 3 directly. More specifically, the insulating member 60 is connected to the core 3 with a connecting member 80 interposed therebetween. By connecting the connecting member 80 to a portion of the core 3, it becomes possible to prevent the magnetostriction-associated decrease in an inductance value. It is also possible that the insulating member 60 is not connected to the core 3 with the connecting member 80 interposed therebetween and is embedded in the core 3. In this case, the insulating member 60 is not connected to the core 3 directly, either.

The connecting member 80 is provided between the first end surface 301 of the core 3 and the third portion 60c of the insulating member 60. As a result, it becomes possible to make the attachment of the insulating member 60 to the core 3 stable while reducing the influence of magnetostriction on the core 3.

An example of the material for the connecting member 80 is a soft resin such as a urethane resin and a silicon resin. By providing the soft resin, it becomes possible to reduce the influence of magnetostriction.

In FIG. 6, the connecting member 80 is provided on the whole area between the first end surface 301 of the core 3 and the third portion 60c of the insulating member 60. However, the connecting member 80 may be provided only on a portion of the area. In FIG. 6, the connecting member 80 is provided between the first end surface 301 of the core 3 and the third portion 60c of the insulating member 60. However, the connecting member 80 may also be provided between the inner peripheral surface 303 of the core 3 and the first portion 60a of the insulating member 60, or may be provided between the outer peripheral surface 304 of the core 3 and the second portion 60b of the insulating member 60, or may be provided at a plurality of sites in any one of the above-mentioned areas.

As shown in FIG. 7, it is preferred that an extended plane 60a1 of the first portion 60a of the insulating member 60 on a side of the second straight portion 410y2 of the bent pin member 410 intersects a first curved portion 410z1. The extended plane 60a1 is a plane shown with an alternate long and short dash line in FIG. 7.

The first curved portion 410z1 is a part of which the inner surface has a radius of curvature R2, and is a region located between the first straight portion 410y1 and the second straight portion 410y2 in FIG. 7. In FIG. 7, an interface between the first straight portion 410y1 and the curved portion 410z1 is referred to as a “first interface 401yz1”, and an interface between the second straight portion 410y2 and the first curved portion 410z1 is referred to as a “second interface 401yz2”, and each of the interfaces is indicated with an alternate long and two short dashes line. The first interface 401yz1 intersects the extending direction of the first straight portion 410y1 at right angles, and the second interface 401yz2 intersects the extending direction of the second straight portion 410y2 at right angles.

As a result, it becomes possible to increase the size of the core 3 in a direction in which the inner peripheral surface 303 of the core 3 is brought close to the second straight portion 410y2 in the bent pin member 410, and consequently it becomes possible to further increase the cross-sectional area of an XZ-direction cross section of the core 3.

Similarly, an extended plane 60b1 of the second portion 60b of the insulating member 60 on a side of the third straight portion 410y3 of the bent pin member 410 intersects a second curved portion 410z2. As a result, it becomes possible to increase the size of the core 3 in a direction in which the outer peripheral surface 304 of the core 3 is brought close to the third straight portion 410y3 in the bent pin member 410, and consequently it becomes possible to further increase the cross-sectional area of an XZ-direction cross section of the core 3.

As shown in FIG. 8, it is preferred that the ratio of a shortest distance t1 to a shortest distance t0 falls within the range from 0.2 to 0.9 inclusive, wherein the shortest distance t1 is a shortest distance between the end surface 60a2 of the first portion 60a of the insulating member 60 which is located on a side of the second end surface 302 and the extended plane 60c1 of an inner surface of the third portion 60c (i.e., a surface of the core 3 which is located on a side of the first end surface 301), and the shortest distance t0 is a shortest distance between the first end surface 301 and the second end surface 302 of the core 3. The shortest distance t0 is the height of the core 3 as observed in the Z-direction, and the shortest distance t1 is the height of the first portion 60a as observed in the Z-direction.

When the ratio is 0.2 or more, the insulation between the core 3 and the first coil 41 can be made more satisfactory. Furthermore, the creepage distance can be kept long, and the occurrence of creeping discharge can be prevented easily. The term “creeping discharge” as used herein refers to a phenomenon that an electric current flows from the electrically conductive body part 410a in the bent pin member 410 to the core 3 through the first portion 60a of the insulating member 60. The term “creepage distance” as used herein refers to the length of the first portion 60a of the insulating member. When the ratio is 0.9 or less, the interference of an end surface of the first portion 60a of the insulating member 60 with the inner surface of the first curved portion 410z1 can be prevented.

For example, it has been confirmed that, in the case where the diameter of each of the bent pin member and the straight pin member 412 is 1.0 mm and the length of the electrically conductive body part 410a exposed from the coating film 410b in the second straight portion 410y2 of the bent pin member 410 is 2.0 mm, the occurrence of creeping discharge against voltage resistance to 2 kV can be prevented.

It is preferred that the second portion 60b of the insulating member 60 has the same configuration.

As shown in FIG. 6, the inductor component 1 is further provided with a coat member 90 that covers a portion of each of the first coil 41 and the second coil 42. More specifically, the coat member 90 covers the electrically conductive body part 411a, 412a, 410a which is exposed from the coating film 410b in the first coil 41 and the electrically conductive body part 421a, 422a, 420a which is exposed from the coating film 420b in the second coil 42. That is, the coat member 90 also covers the welded portions.

As mentioned above, the coat member 90 is provided on the side of the first end surface 301 of the core 3, i.e., on the side of the bottom plate part 21 of the core. When the coat member 90 is arranged on the side of the bottom plate part 21, all of members formed from resins, specifically the coat member 90, the insulating member 60 and the connecting member 80, can be located on the side of the bottom plate part 21. In the members formed from resins, heat is sometimes stored during the use of the inductor component. However, by providing the members close together on the side of the bottom plate part 21, the heat can be discharged easily through the bottom plate part 21. Furthermore, the coat member 90 can prevent the misalignment of the first coil 41 and the second coil 42. Furthermore, when the coat member 90, the insulating member 60 and the connecting member 80 are arranged on the side of the bottom plate part 21, the center of gravity of the inductor component 1 can be moved on the side of the bottom plate part 21, and therefore the stability upon the installation of the inductor component 1 can be improve.

As one example of the material for the coat member 90, a heat-curable epoxy resin can be used.

The coat member 90 may be provided at a site which is not located on the side of the bottom plate part 21, i.e., a site which is not located on the first end surface 301 side of the core 3. For example, the coat member 90 may be arranged on the second end surface 302 side of the core 3. The coat member 90 may also cover a portion of the electrically conductive body part 410a, 420a in the bent pin member 410, 420 and a portion of the electrically conductive body part 412a, 422a in the second straight pin member 412, 422.

In the present application, the coat member 90 is described as a member that is different from the insulating member 60. However, it is possible to omit the coat member 90 and use the insulating member 60 as a member having a thickness sufficient for covering the welded portion. In other words, the insulating member 60 may also serve as the coat member 90. Furthermore, the connecting member 80 is described as a member that is different from the insulating member 60. However, it is possible to omit the connecting member 80 and connect the insulating member 60 to the core 3 directly. In other words, the insulating member 60 may also serve as the connecting member 80. The insulating member 60 may be located at a region other than the region between the welded portion and the core 3.

### Method for Manufacturing Inductor Component

Next, the method for manufacturing the inductor component 1 is described.

As shown in FIG. 3, the first coil 41 and the second coil 42 are wound around the core 3 having the insulating member 60 fitted thereinto in such a manner that the winding axes of the first coil 41 and the second coil 42 become parallel with each other, so that at least a portion of the exposed electrically conductive body part 411a, 412a, 410a in the first coil 41 and at least a portion of the exposed electrically conductive body part 421a, 422a, 420a in the second coil 42 are located on the first end surface 301 side of the core 3.

Subsequently, the pin members in the first coil 41 are welded separately and the pin members in the second coil 42 are welded separately while keeping the first end surface 301 of the core 3 upward.

Subsequently, as shown in FIG. 4, the core 3 and the coils 41 and 42 are attached onto the bottom plate part 21, and then the lid part 22 is placed over these components to house these components in the case 2. In this manner, the inductor component 1 is manufactured.

By employing this manufacturing method, it becomes possible to reduce the number of steps for the manufacturing of the inductor component 1 and to manufacture the inductor component 1 more easily.

### Second Embodiment

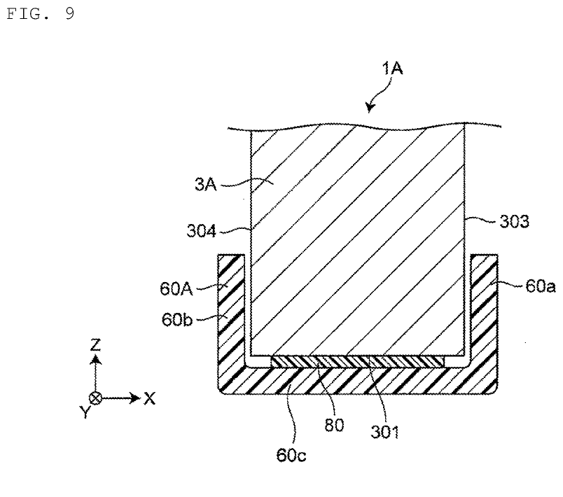

FIG. 9 is an enlarged sectional view of an inductor component 1A according to a second embodiment. In FIG. 9, a part of a cross section of the inductor component 1A as observed in the XZ-direction is shown.

The inductor component 1A is different from the inductor component 1 of the first embodiment in the shape of the core. This different point is described hereinbelow. Other points in the configuration are the same as those of the first embodiment and are indicated using the same symbols as those employed in the first embodiment, and the explanation about the same points in the configuration is omitted.

As shown in FIG. 9, a core 3A of the inductor component 1A according to this embodiment does not have the fitting groove 35 for the core 3 which is described in the first embodiment. The cross section of the core 3A in the XZ-direction is quadrilateral.

By employing this configuration, the insulation between the core 3A and the first coil 41 and the second coil 42 can be secured. Furthermore, it becomes possible to increase the cross-sectional area of the cross section of the core 3A in the XZ-direction compared with the case where the whole area of the surface of the core is covered with an insulating member.

In this embodiment, it also becomes possible to insulate the welded portion from the core 3A by providing the insulating member. Furthermore, because a portion of the core 3A is covered with the insulating member, the influence of magnetostriction can be reduced compared with the case where the whole surface of the core is covered with the insulating member. Furthermore, according to this aspect, a part occupied by the insulating member can be replaced by the core and thereby the cross-sectional area of the core 3A can be increased compared with the case where the whole surface of the core is covered with the insulating member. As a result, according to this aspect, the inductance value of the inductor component 1A can be increased.

### Third Embodiment

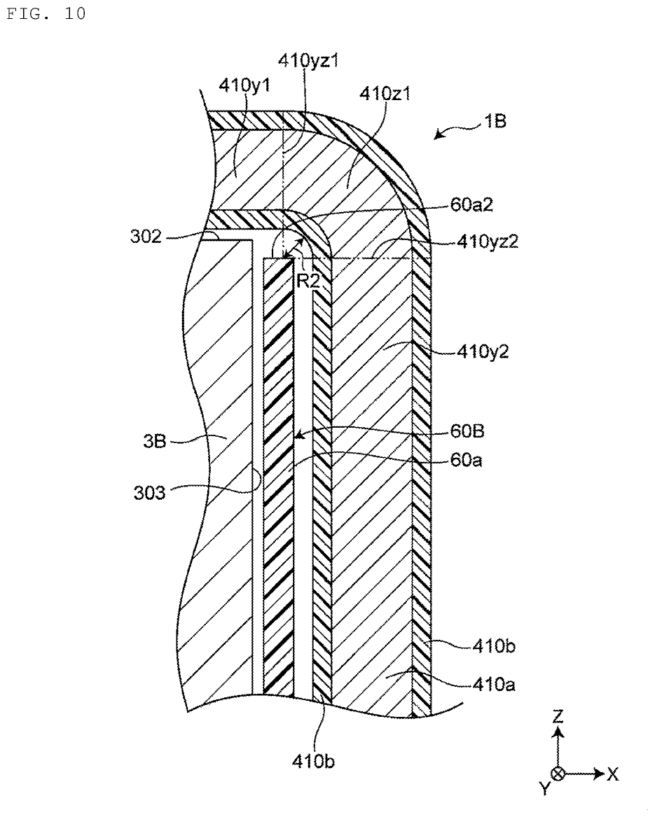

FIG. 10 is an enlarged sectional view of an inductor component 1B according to a third embodiment. In FIG. 10, a part of a cross section of the inductor component 1B as observed in the XZ-direction is shown.

The inductor component 1B is different from the inductor component 1 of the first embodiment in the shapes of the core and the insulating member. This different point is described hereinbelow. Other points in the configuration are the same as those of the first embodiment and are indicated using the same symbols as those employed in the first embodiment, and the explanation about the same points in the configuration is omitted.

As shown in FIG. 10, a core 3B of the inductor component 1B according to this embodiment does not have the fitting groove 35 for the core 3 which is described in the first embodiment. In FIG. 10, the shape of the cross section of the core 3B in the XZ-direction is quadrilateral.

An insulating member 60B of the inductor component 1B of this embodiment has a first portion 60a located between an inner peripheral surface 303 of the core 3B and a second straight portion 410y2 of a pin members 410, wherein an end surface 60a2 of the first portion 60a on a second end surface 302 side (i.e., a first straight portion 410y1 side) is located on the same plane as that of an interface 410yz2 of a bent pin member 410. The interface 410yz2 is an interface between the second straight portion 410y2 and the first curved portion 410z1 in the bent pin member 410. For example, with referring to the first embodiment (FIG. 6), the ratio of a shortest distance t1 to a shortest distance t0 is 0.9, wherein the shortest distance t1 is a shortest distance between an end surface 60a2 of the first portion 60a of the insulating member 60 which is located on a side of the second end surface 302 and the extended plane 60c1 of an inner surface of the third portion 60c (i.e., a surface of the core 3 which is located on a side of the first end surface 301), and the shortest distance t0 is a shortest distance between the first end surface 301 and the second end surface 302 of the core 3.

As a result, the cross-sectional area of the cross section of the core 3B in the XZ-direction can be increased, the insulation between the core 3B and the first coil 41 can be secured, and the interference of the end surface 60a2 of the first portion 60a in the insulating member 60B with the inner surface of the first curved portion 410z1 can be prevented.

In this embodiment, it also becomes possible to insulate the welded portion from the core 3B by providing the insulating member. Furthermore, because a portion of the core 3B is covered with the insulating member, the influence of magnetostriction can be reduced compared with the case where the whole surface of the core is covered with the insulating member. Furthermore, according to this aspect, a part occupied by the insulating member can be replaced by the core and thereby the cross-sectional area of the core 3B can be increased compared with the case where the whole surface of the core is covered with the insulating member. As a result, according to this aspect, the inductance value of the inductor component 1B can be increased.

### Fourth Embodiment

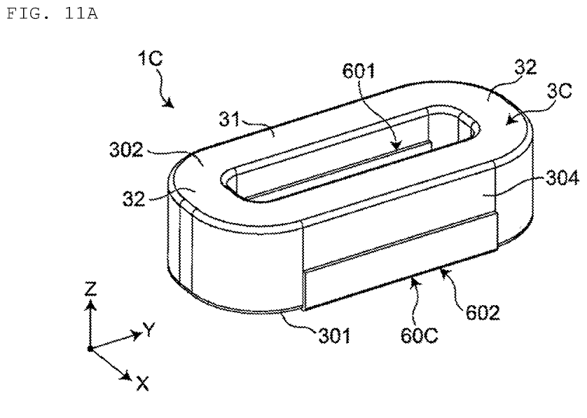

FIG. 11A is an upper perspective view of an inductor component 1C according to a fourth embodiment, and FIG. 11B is an exploded perspective view of FIG. 11A.

The inductor component 1C is different from the inductor component 1 of the first embodiment in the shapes of the core and the insulating member. This different point is described hereinbelow. Other points in the configuration are the same as those of the first embodiment and are indicated using the same symbols as those employed in the first embodiment, and the explanation about the same points in the configuration is omitted.

As shown in FIGS. 11A and 11B, a core 3C of the inductor component 1C according to this embodiment does not have the fitting groove 35 for the core 3 which is described in the first embodiment. In FIG. 11, the shape of the cross section of the core 3C in the XZ-direction is quadrilateral.

Unlike the inductor component 1 of the first embodiment, an insulating member 60C of the inductor component 1C of this embodiment has a first insulating member 601 and a second insulating member 602 that are independent from each other. The first insulating member 601 is arranged between the core 3C and a first coil 41, and the second insulating member 602 is arranged between the core 3C and a second coil 42.

The first insulating member 601 has a first portion 601a, a second portion 601b and a third portion 601c. The first portion 601a is located between an inner peripheral surface 303 of the core 3C and the first coil 41, the second portion 601b is located between an outer peripheral surface 304 of the core 3C and the first coil 41, and the third portion 601c is located between a first end surface 301 of the core 3C and the first coil 41.

The second insulating member 602 has a first portion 602a, a second portion 602b and a third portion 602c. The first portion 602a is located between the inner peripheral surface 303 of the core 3C and the second coil 42, the second portion 602b is located between the outer peripheral surface 304 of the core 3C and the second coil 42, and the third portion 602c is located between the first end surface 301 of the core 3C and the second coil 42.

That is, in this embodiment, only a partial region of the first end surface 301 of the core 3C (i.e., a region on which the first coil 41 and the second coil 42 are located) is covered with the first insulating member 601 and the second insulating member 602.

As a result, the insulation between the core 3C and the first coil 41 and the second coil 42 can be secured even if a region other than the partial region of the first end surface 301 of the core 3C is not covered. Furthermore, in the fourth embodiment, because the area covered with the insulating members on the surface of the core is smaller compared with that in the first embodiment, the influence of magnetostriction can be further reduced and there is an advantage with respect to the reduction in cost for materials. Furthermore, according to this aspect, a part occupied by the insulating members can be replaced by the core and thereby the cross-sectional area of the core 3C can be increased compared with the case where the whole surface of the core is covered with the insulating member. As a result, according to this aspect, the inductance value of the inductor component 1C can be increased.

### Fifth Embodiment

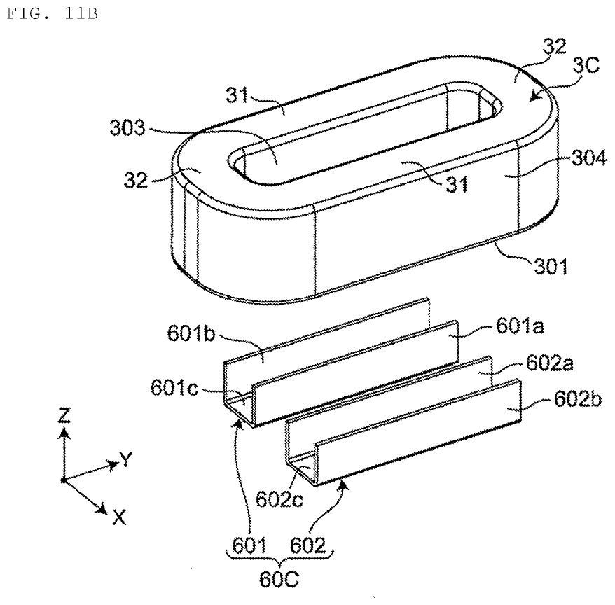

FIG. 12 is an enlarged sectional view of an inductor component 1D according to a fifth embodiment. In FIG. 12, a part of a cross section of the inductor component 1D as observed in the XZ-direction is shown.

The inductor component 1D is different from the inductor component 1 of the first embodiment in the shapes of the core and the insulating member and the configuration of pin members. This different point is described hereinbelow. Other points in the configuration are the same as those of the first embodiment and are indicated using the same symbols as those employed in the first embodiment, and the explanation about the same points in the configuration is omitted.

As shown in FIG. 12, a core 3D of the inductor component 1D according to this embodiment does not have the fitting groove 35 for the core 3 which is described in the first embodiment. In FIG. 12, the shape of the cross section of the core 3D in the XZ-direction is quadrilateral.

An insulating member 60D of the inductor component 1D of this embodiment does not have the second portion 60b of the insulating member 60 in the first embodiment, and the length of a third portion 60c in the insulating member 60 is shorter than that in the first embodiment. In the insulating member 60D, the first portion 60a is provided on an inner peripheral surface 303 of the core 3D, and the third portion 60c is provided on a part of the first end surface 301 of the core 3D. The insulating member 60D is provided over a portion of the first end surface 301 and a portion of the inner peripheral surface 303 of the core 3D.

In the fifth embodiment, because the area covered with the insulating member on the surface of the core is small, the influence of magnetostriction can be further reduced. Furthermore, the fifth embodiment is advantageous from the viewpoint of the reduction in cost for materials. Furthermore, according to this aspect, a part occupied by the insulating members can be replaced by the core and thereby the cross-sectional area of the core 3C can be increased compared with the case where the whole surface of the core is covered with the insulating member. As a result, according to this aspect, the inductance value of the inductor component 1C can be increased.

This embodiment is particularly effective when a welded portion is present in the vicinity of a corner part formed between the inner peripheral surface 303 and the first end surface 301 of the core 3D. More specifically, the coil has a third pin member constituting a single turn, and the welded portion has a third welded portion which is provided on the third pin member in one of adjacent turns and a third pin member in the other of the adjacent turns.

The insulating member 60D is connected to the core 3D with the connecting member 80 interposed therebetween. The position at which the connecting member 80 is provided is not limited to the position shown in FIG. 12.

In this embodiment, the position at which the insulating member 60D is arranged is not limited to the above-mentioned position, it is only required to arrange the insulating member 60D between at least one welded portion and the core 3D, and the insulating member 60D may be arranged between each of all of the welded portions and the core 3D.

### Sixth Embodiment

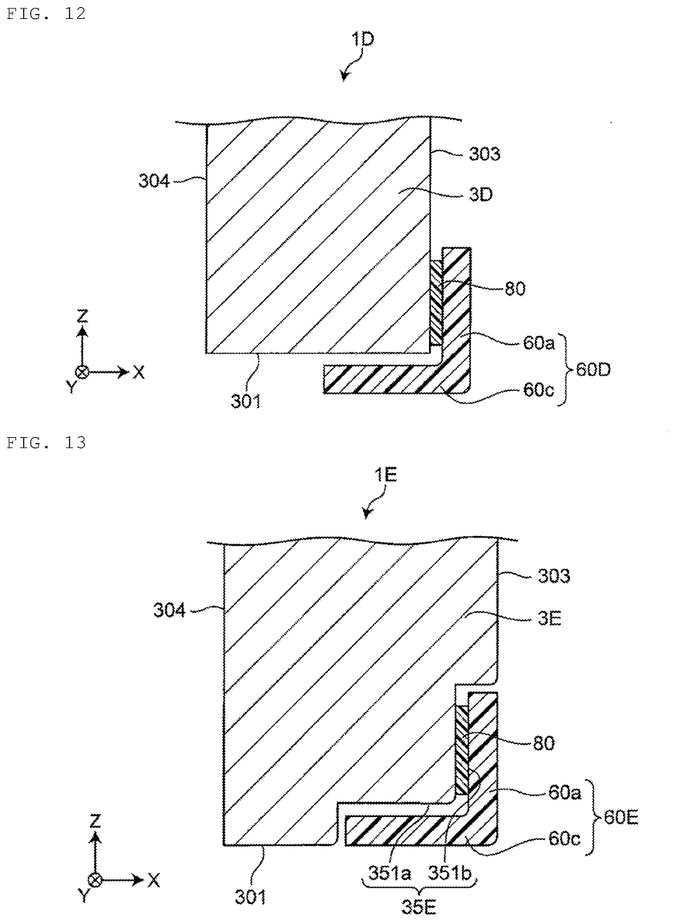

FIG. 13 is an enlarged sectional view of an inductor component 1E according to a sixth embodiment. In FIG. 13, a part of a cross section of the inductor component 1E as observed in the XZ-direction is shown.

The inductor component 1E is different from the inductor component 1 of the first embodiment in the shapes of the core and the insulating member. This different point is described hereinbelow. Other points in the configuration are the same as those of the first embodiment and are indicated using the same symbols as those employed in the first embodiment, and the explanation about the same points in the configuration is omitted.

As shown in FIG. 13, a core 3E of the inductor component 1E according to this embodiment has a fitting groove 35E which opens to the first end surface 301 and the inner peripheral surface 303 of the core. More specifically, the fitting groove 35E has a cavity 351a on the first end surface 301 side of the core 3E and a cavity 351b on the inner peripheral surface 303 side of the core 3E.

An insulating member 60E of the inductor component 1E of this embodiment is different from the insulating member 60 described in the first embodiment in that the insulating member 60E has the first portion 60a and the third portion 60c. In the insulating member 60E, the first portion 60a is provided at the cavity 351a on the inner peripheral surface 303 of the core 3E, and the third portion 60c is provided at the cavity 351b formed on the first end surface 301 of the core 3E.

As a result, the extension of the insulating member 60E beyond the edge of outer surface of the core 3E can be reduced. Furthermore, the insulating member 60E can be attached to the core 3E easily, and the misalignment of the insulating member 60E can be prevented. In the sixth embodiment, because the area covered with the insulating member on the surface of the core is small, the influence of magnetostriction can be further reduced. Furthermore, the sixth embodiment is advantageous from the viewpoint of the reduction in cost for materials. Furthermore, according to this aspect, a part occupied by the insulating members can be replaced by the core and thereby the cross-sectional area of the core 3E can be increased compared with the case where the whole surface of the core is covered with the insulating member. As a result, according to this aspect, the inductance value of the inductor component 1E can be increased.

The insulating member 60E is connected to the core 3E with the connecting member 80 interposed therebetween. The position at which the connecting member 80 is provided is not limited to the position shown in FIG. 13.

In this embodiment, the position at which the insulating member 60E is provided is not limited to the above-mentioned position, it is only required to provide the insulating member 60E between at least one welded portion and the core 3E, and the insulating member 60E may be provided between all of the welded portions and the core 3E.

As mentioned above, in the first to sixth embodiments, the inner peripheral surface 303 and the outer peripheral surface 304 respectively correspond to the second surface and the third surface recited in the claims. However, the inner peripheral surface 303 and the outer peripheral surface 304 may respectively correspond to the third surface and the second surface recited in the claims.

The present disclosure is not limited to the above-described embodiments, and can be modified without departing from the spirit and scope of the present disclosure. For example, the characteristic features of the first to sixth embodiments may be combined in various ways. The shape of the case and the shape of the core are not limited to those mentioned in the embodiments, and may be modified.

Also, the number of the coils is not limited to those mentioned in the embodiments, and may be modified.

What is claimed is:

1. An inductor component comprising:
a ring-shaped core;
an insulating member which covers a portion of the core; and
a coil which is wound around the core and the insulating member, the coil comprising a plurality of pin members in which end portions of adjacent pin members share a welded portion at which the end portions are welded to each other, and the insulating member being located between the welded portion and the core.

2. The inductor component according to claim 1, wherein
the insulating member is indirectly connected to the core.

3. The inductor component according to claim 1, wherein
the plurality of pin members include a first pin member and a second pin member,
the first pin member and the second pin member together constitute a single turn,
in adjacent turns, the welded portion includes
a first welded portion at which the first pin member in one of the turns and the second pin member in the one of the turns are welded to each other, and
a second welded portion at which the first pin member in the one of the turns and the second pin member in the other of the turns are welded to each other,
the core has a first surface, a second surface which intersects the first surface, and a third surface which faces the second surface and intersects the first surface,
the first welded portion is located above at least one of the first surface and the second surface,
the second welded portion is located above at least one of the first surface and the third surface, and
the insulating member is provided over the first surface, a portion of the second surface and a portion of the third surface.

4. The inductor component according to claim 1, wherein
the plurality of pin members include a third pin member which constitutes a single turn,
in adjacent turns, the welded portion includes a third welded portion which is provided at the third pin member in one of the turns and the third pin member in the other of the turns,
the core has a first surface and a second surface which intersects the first surface,
the third welded portion is located above at least one of the first surface and the second surface, and
the insulating member is provided over a portion of the first surface and a portion of the second surface.

5. The inductor component according to claim 1, wherein
the core has a fitting groove into which the insulating member is fitted.

6. The inductor component according to claim 1, wherein
the fourth surface of the core which the welded portion does not face is not covered with the insulating member.

7. The inductor component according to claim 1, wherein
the core has a fourth surface which the welded portion does not face, and a second surface which intersects the fourth surface,
the pin member has a first straight portion which faces the fourth surface, a second straight portion which faces the second surface, and a curved portion which is located between the first straight portion and the second straight portion,
the insulating member has a first portion which is located between the second surface of the core and the second straight portion of the pin member, and
an extended plane of the first portion of the insulating member which is located on a side of the second straight portion intersects the curved portion of the pin member.

8. The inductor component according to claim 1, wherein
the core has a fourth surface which the welded portion does not face, and a second surface which intersects the fourth surface,
the pin member has a first straight portion which faces the fourth surface, a second straight portion which faces the second surface, and a curved portion which is located between the first straight portion and the second straight portion,
the insulating member has a first portion which is located between the second surface of the core and the second straight portion of the pin member, and
an end surface of the first portion of the insulating member which is located on the first straight portion side is on the same plane as an interface between the second straight portion and the curved portion of the pin member.

9. The inductor component according to claim 1, wherein
the core has a first surface, a fourth surface which faces the first surface and which the welded portion does not face, and a second surface which intersects the first surface and the fourth surface,
the pin member has a straight portion which faces the second surface,
the insulating member has a first portion which is located between the second surface of the core and the straight portion of the pin member, and a third portion which faces the first surface of the core, and
a ratio of a shortest distance between an extended plane of the third portion of the insulating member which is located on the first surface side and an end surface of the first portion of the insulating member to a shortest distance between the first surface and the fourth surface of the core is from 0.2 to 0.9.

10. The inductor component according to claim 1, wherein
the plurality of pin members include a first pin member and a second pin member,
the first pin member and the second pin member together constitute a single turn,
in adjacent turns, the welded portion includes
a first welded portion at which the first pin member in one of the turns and the second pin member in the one of the turns are welded to each other, and
a second welded portion at which the first pin member in the one of the turns and the second pin member in the other of the turns are welded to each other,
the core has a first surface, a second surface which intersects the first surface, and a third surface which faces the second surface and intersects the first surface,
the first welded portion is located above at least one of the first surface and the second surface,
the second welded portion is located above at least one of the first surface and the third surface, and
the insulating member is provided over the first surface, a portion of the second surface and a portion of the third surface.

11. The inductor component according to claim 2, wherein
the plurality of pin members include a third pin member which constitutes a single turn,
in adjacent turns, the welded portion includes a third welded portion which is provided at the third pin member in one of the turns and the third pin member in the other of the turns,
the core has a first surface and a second surface which intersects the first surface,
the third welded portion is located above at least one of the first surface and the second surface, and
the insulating member is provided over a portion of the first surface and a portion of the second surface.

12. The inductor component according to claim 2, wherein
the core has a fitting groove into which the insulating member is fitted.

13. The inductor component according to claim 3, wherein
the core has a fitting groove into which the insulating member is fitted.

14. The inductor component according to claim 2, wherein
the fourth surface of the core which the welded portion does not face is not covered with the insulating member.

15. The inductor component according to claim 3, wherein
the fourth surface of the core which the welded portion does not face is not covered with the insulating member.

16. The inductor component according to claim 2, wherein
the core has a fourth surface which the welded portion does not face, and a second surface which intersects the fourth surface,
the pin member has a first straight portion which faces the fourth surface, a second straight portion which faces the second surface, and a curved portion which is located between the first straight portion and the second straight portion,
the insulating member has a first portion which is located between the second surface of the core and the second straight portion of the pin member, and
an extended plane of the first portion of the insulating member which is located on a side of the second straight portion intersects the curved portion of the pin member.

17. The inductor component according to claim 3, wherein
the core has a fourth surface which the welded portion does not face, and a second surface which intersects the fourth surface,
the pin member has a first straight portion which faces the fourth surface, a second straight portion which faces the second surface, and a curved portion which is located between the first straight portion and the second straight portion,
the insulating member has a first portion which is located between the second surface of the core and the second straight portion of the pin member, and
an extended plane of the first portion of the insulating member which is located on a side of the second straight portion intersects the curved portion of the pin member.

18. The inductor component according to claim 2, wherein
the core has a fourth surface which the welded portion does not face, and a second surface which intersects the fourth surface,
the pin member has a first straight portion which faces the fourth surface, a second straight portion which faces the second surface, and a curved portion which is located between the first straight portion and the second straight portion,
the insulating member has a first portion which is located between the second surface of the core and the second straight portion of the pin member, and
an end surface of the first portion of the insulating member which is located on the first straight portion side is on the same plane as an interface between the second straight portion and the curved portion of the pin member.

19. The inductor component according to claim 3, wherein
the core has a fourth surface which the welded portion does not face, and a second surface which intersects the fourth surface,
the pin member has a first straight portion which faces the fourth surface, a second straight portion which faces the second surface, and a curved portion which is located between the first straight portion and the second straight portion,
the insulating member has a first portion which is located between the second surface of the core and the second straight portion of the pin member, and
an end surface of the first portion of the insulating member which is located on the first straight portion side is on the same plane as an interface between the second straight portion and the curved portion of the pin member.

20. The inductor component according to claim 2, wherein
the core has a first surface, a fourth surface which faces the first surface and which the welded portion does not face, and a second surface which intersects the first surface and the fourth surface,
the pin member has a straight portion which faces the second surface,
the insulating member has a first portion which is located between the second surface of the core and the straight portion of the pin member, and a third portion which faces the first surface of the core, and
a ratio of a shortest distance between an extended plane of the third portion of the insulating member which is located on the first surface side and an end surface of the first portion of the insulating member to a shortest distance between the first surface and the fourth surface of the core is from 0.2 to 0.9.
